(19) United States
(12) Patent Application Publication
(10) Pub. No.: US 2008/0085347 A1
(43) Pub. Date: Apr. 10, 2008

(54) Vacuum marination device

(76) Inventors: Pat Y. Mah, Kowloon (HK); Alexander Joseph Kalogroulis, Surrey (GB)

Correspondence Address: Harrington & Harrington;Curtis L. Harrington, Suite 250, 6300 State University Drive, Long Beach, CA, 90815, US

(21) Appl. No.: 11/544,193

(22) Filed: Oct. 6, 2006

(51) Int. Cl. A23L 1/31

(52) U.S. Cl. 426/281

(57) ABSTRACT

The preferred embodiment of the present invention involves a device and a process which allows a user to first depress a primary plunger to evacuate essentially all of the air from a chamber in which food items in a marinade are sealably contained. Once the excess air is forced from the container so that the primary plunger is in full contact with the marinade, a locking member is used to fix the position of the primary plunger relative to a lid on the device. A vacuum is then pulled by manually activating a secondary plunger to create a near-full vacuum inside the container. Because essentially all of air is removed from the container before pulling the vacuum, achieving a near-full vacuum can be accomplished in a short amount of time with a minimum amount of effort on the part of the user.

### FIELD OF THE INVENTION

The present invention relates to a device and a process for marinating food items (such as meat, fish, or vegetables) which utilizes a powerful vacuum that is quickly and easily activated to pull air and fluids from food items in a sealed container to allow a marinade to more readily infuse into the food items so that later cooking processes applied to the food items will result in more tender, more flavorful, and more moist end-products than may be achieved through the use of conventional marinating methods.

### BACKGROUND OF THE INVENTION

Typically, marinating food such as meat, fish, or vegetables is desirable for infusing flavor into the food or to pull fluid into the food to prevent drying during cooking or to achieve tenderness, as with brining. The simplest and most conventional method of marinating food is to submerse the food in a marinade in a simple container, such as a plastic bag or lidded bowl, usually under refrigeration to ensure that the food stays fresh during the marination process. There are several problems associated with this method of marinating, the most notable of which is the time it takes for the marinade to achieve the desired effect in terms of flavor, tenderness, or hydration of the food. Usually, more than 24 hours of marination will be necessary to achieve the desired result. Often, however, even 48 hours of marination may be insufficient if the goal is to season or tenderize a particularly tough cut of meat, because meat is fairly impermeable as a general rule, and particularly so if the cut of meat is a sinewy one. Even if the food is kept under refrigeration, extended marination times may rob the food of its freshness and color.

Another problem with the traditional method of marinating food is that it requires preparing a volume of marinade sufficient to entirely cover the food on all sides. Because maintaining the proper concentration of marinade requires an increase in liquid ingredients, spices, and seasonings, large volumes of marinade can be rather expensive to prepare. If too little marinade is used (e.g., in an effort to be economical), the container must be inverted on a regular basis during the marinating process to ensure that the marinade reaches all surfaces of the food. This can be frustrating for several reasons.

First, one must remember to invert or shake a conventional container every few hours so that the marinade is distributed over all food surfaces. Second, if shaking or inverting the conventional container does not help the marinade to reach all surfaces of the food, the container must be opened and the food must be rearranged manually. Third, even where inverting and shaking the conventional container is effective in distributing the marinade to all surfaces of the food, it almost invariably results in leakage of the contents because most containers are not completely air-tight.

A leaky or opened conventional container is likely to necessitate a thorough cleaning of all surfaces affected by splash or splatter to avoid potential illnesses from cross-contamination, especially where raw meat is being marinated. Finally, marination may be spotty, and therefore largely ineffective, where a low volume of marinade is used.

A more recently developed method of marination is the use of a vacuum to open small pores in the food into which the marinade can then infuse. The vacuum may be achieved by using either an electric or a manual pump. In large-scale commercial food preparation, the food to be marinated is placed into a sealed container and the pressure inside the container is typically lowered using an electric pump. For home cooks, electric vacuum marination devices can be prohibitively expensive; moreover, such devices can be quite cumbersome to store and inconvenient to use, because most require attachment of a separate vacuum hose and pump.

Even manual pumps designed specifically for small-scale food preparation, such as that engaged in by home cooks, can be time-consuming and labor-intensive, as conventional pumps may require 20 strokes or more to achieve an acceptably effective vacuum, and far more than 20 strokes if there is a large volume of air inside the container initially.

The primary concern with most manual pumps, however, is that the maximum vacuum achievable may not be strong enough to enable a significant influx of marinade into the food products. Even assuming no air in the sealed container prior to pumping (which is usually not the case), twenty strokes of a typical manually-activated vacuum pump produce only about a 62% vacuum inside the container.

What is therefore needed is a manually-activated vacuum marination device which will allow a user to evacuate essentially all of the air from a container prior to pulling a vacuum, so that a full vacuum can be quickly achieved with only minimum user effort. The optimum vacuum marination device will be affordable, fast, easy to use, and convenient to store; additionally, in cases where the food to be marinated is compressible, the device should enable effective use of smaller amounts of marinade, thereby affording a user even further savings in terms of food preparation costs.

### SUMMARY OF THE INVENTION

The preferred embodiment of the present invention involves a device and a process which allows a complete vacuum to be drawn. A container has a variable volume into which food items and a marinade liquid can be placed. The container has a concave bottom to ensure that the marinade is distributed to as much of the surface area of the food as possible and resist deformation due to the pressure experienced when the pressure in the container is lowered. A variable displacement plunger is provided and can be closed around the foodstuffs which are submerged in the marinade to reduce the space surrounding the foodstuffs up to the level of the marinade to force air from the container.

A locking member is used to fix the position of the plunger relative to a lid on the device once the excess air is forced from the container. The lid fits securely along the top rim of the container. The device is then manually activated by withdrawing a piston from a first position in which the piston extends past the plunger and down into the container (which allows air to escape past the piston as the plunger is advanced into the container) to a second position in which the piston is retracted up through the cylinder of the plunger, sealing the container and creating a potentially full vacuum.

Where a water based marinade is used, the level of vacuum will be limited by the vapor pressure of water of about 24 millimeters of mercury at room temperature, about 24/760=3%. Other marinades based upon olive oil and the like have negligible vapor pressure and should produce the most complete vacuum.

Usually, the food items may contain a small volume of trapped air at atmospheric pressure within the food mass; therefore, the pressure inside the sealed container may drop from the initial vacuum of 0 bar to a vacuum of approximately 0.05-0.01 bar as the air escapes from the food, resulting in a final vacuum of about 95% to about 99% for the duration of the marinating process, even where an oil based marinade is used. A combination of the effects from a water based marinade combined with the escape of air should result in a vacuum no lower than 92%.

The piston can be pulled to create the vacuum, and can be locked into place in its extended position during the marination process. During marination, the pores of the food are opened under the vacuum so that the marinade may infuse into the pores. As a result, marination time is significantly less than that required for traditional methods of marinating and can be accomplished in from ¼ hour to 1 hour in most cases, depending on a user's specifications and reasons for marinating.

Because the air is removed from the container before pulling the vacuum, achieving a full vacuum can be accomplished in a short amount of time with minimum effort on the part of the user. Additionally, only a small volume of marinade may be sufficient where the food to be marinated can be easily compressed.

The vacuum marination device of the present invention may also be used to quickly re-hydrate dried foods, such as dried fruit or mushrooms, by rapidly replacing the air in the pores of the dried foods with water or some other liquid. This method of re-hydration would preclude the need to (1) wait hours for the dried food to re-absorb its lost liquid at room temperature, or (2) boil the dried food to accelerate re-hydration, potentially losing valuable nutrients in the process. Further, the time saved by avoiding soaking or boiling the dried food coupled with the ease of storing dried food would simplify the task of fully stocking a kitchen from a food spoilage perspective, because dried foods generally have a longer shelf life than fresh foods.

### BRIEF DESCRIPTION OF THE DRAWINGS

The invention, its configuration, construction, and operation will be best further described in the following detailed description, taken in conjunction with the accompanying drawings in which:

FIG. 1 is an exploded partially cutaway view of a first embodiment of a vacuum marination device which illustrates a container with foodstuff and marinade therein, a plunger member comprising a domed portion and a cylinder portion, a lid member, a locking member, a reservoir member, and a piston having a first stopper end, a second handle end, and a shaft extending therebetween;

FIG. 2 is a partial cutaway view of the vacuum marination device shown in FIG. 1 as assembled;

FIG. 3 is a partial cutaway view of the vacuum marination device shown in FIGS. 1 and 2 in which the device is both assembled and activated;

FIG. 4 is a cross-sectional view of a second embodiment of the vacuum marination device and illustrates a container, a plunger axially movable inside the container by a threaded shaft, a handle for advancing and retracting the threaded shaft, and an end cap for controlling air flow into the container;

FIG. 5 is a cutaway view of a third embodiment of the vacuum marination device which illustrates a container expanded by intermediate stacking sections and serviceable using a variety of pumping mechanisms, and

FIG. 6 is a cutaway view of a fourth embodiment of the vacuum marination device which illustrates a fixed volume container that can be used without need for a plunger and is serviceable using a variety of pumping mechanisms and which illustrates the use of a separating plate which can be used to allow a shortfall of marinade to be supplemented using another liquid such as water or oil to displace the air space in the container to allow a greater vacuum to be achieved more rapidly.

### DETAILED DESCRIPTION OF THE PREFERRED EMBODIMENT

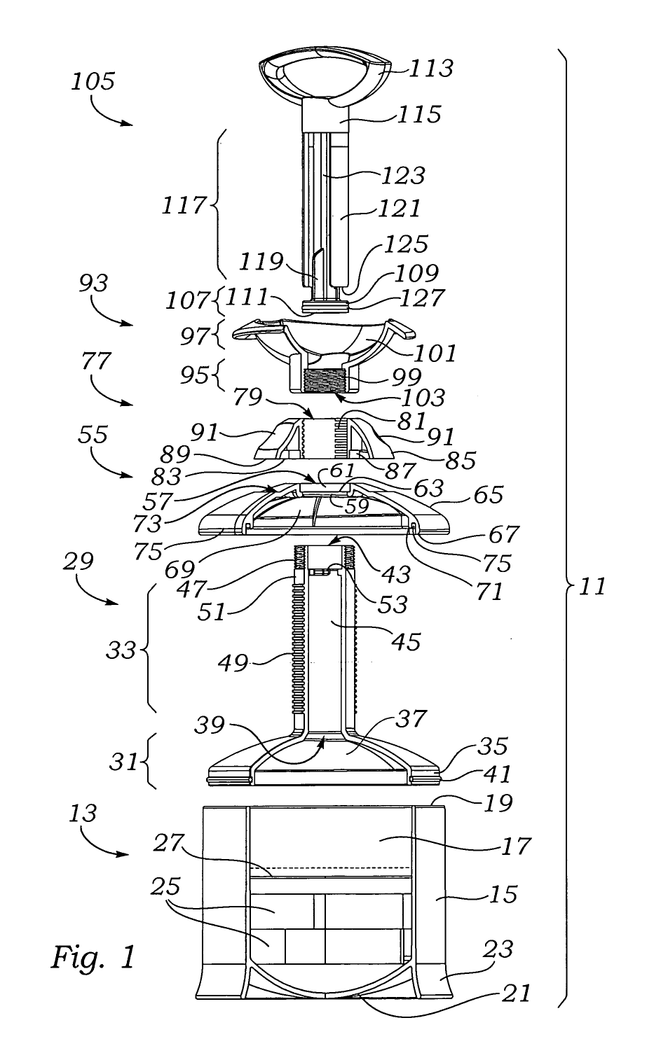

The description of the vacuum marination device of the present invention is best described with reference first to FIG. 1, which is an exploded cutaway view of the first embodiment of the vacuum marination device 11 illustrating a container 13 with a side wall 15 having an inner surface 17, a top rim 19, and a bottom wall 21. Side wall 15 extends beyond bottom wall 21 to form a flange 23 on which container 13 rests. Container 13 is illustrated as oval in FIG. 1, but may be one of any number of shapes, such as round, square, or rectangular. Container 13 is illustrated as containing foodstuff 25 and a liquid marinade 27 covering foodstuff 25. Bottom wall 21 of container 13 is concave to allow foodstuff 25 to immerse within the liquid marinade 27 as much as possible and to resist deformation due to the pressure from the surrounding atmosphere, which is experienced when the pressure in the container 13 is lowered.

Illustrated directly above container 13 is an annular plunger member 29 forming a domed portion 31 and a cylinder portion 33 adjacent domed portion 31. Domed portion 31 is generally oval, but can be any one of a number of shapes as long as its shape matches that of the side wall of container 13. Domed portion 31 has a side surface 35 and an undersurface 37, and forms a central opening 39 which communicates with the interior space of cylinder portion 33. A gasket 41 is attached to plunger member 29 along the outwardly directed circumference of side surface 35 of domed portion 31. The outside diameter or circumference of domed portion 31 is slightly smaller than the inside diameter or circumference of the inner surface 17 of the side wall of container 13 but is made slightly larger by gasket 41, which may be an “o” ring gasket, so that when the domed portion 31 is inserted into container 13, the gasket 41 will be laterally compressed against the inner surface 17 of side wall 15 of container 13, which will tightly seal foodstuff 25 and marinade 27 inside container 13.

The cylinder portion 33 includes an opening 43 adjacent an inner surface 45 of cylinder portion 33 seen through the removed portion in FIG. 1. Cylinder portion 33 has a first threaded outer surface 47 adjacent opening 43 defining a first outside diameter, a second threaded outer surface 49 adjacent domed portion 31, and an optional intermediate outer surface 51 extending between first threaded outer surface 47 and second threaded outer surface 49. Second threaded outer surface define a second outside diameter of cylinder portion 33 which may be slightly larger in diameter than the first outside diameter defined by first threaded outer surface 47 49 and intermediate outer surface 51 where a threaded arrangement is used. Approximately ½ inch inside opening 43 nearest first threaded outer surface 47 is an inward projection or ledge 53, which may extend circumferentially along two or more portions of the inner surface 45 of cylinder portion 33.

Illustrated directly above plunger member 29 is an annular lid member 55 which is illustrated as being oval but which can be any one of a number of shapes so long as it is enabled to be supported by the side wall 15 of container 13. Lid member 55 forms an opening 57 adjacent a first circumferentially inwardly directed surface 59 which defines a first inside diameter. Above first circumferentially inwardly directed surface 59 an indented surface or groove includes a second inner surface 61 having a second inside diameter slightly larger than the first inside diameter, and an intermediate surface 63 extending between first inner surface 59 and second inner surface 61 and which is perpendicular to the plane curve of both first inner surface 59 and second inner surface 61.

It is understood that the indented surface or groove including first circumferentially inwardly directed surface 59 second inner surface 61 and intermediate surface 63 could be of another configuration, and it need not even be constrained to providing an interfit space adjacent the opening 57. The top of the lid member 55 could be made flat which would enable another object to turn like a nut, against the upper surface of the lid member 55. Other configurations are possible.

Lid member 55 further has an upper surface 65, an outer bottom edge 67, an undersurface 69, and an inner bottom edge 71. The inside diameter of lid member 55 is significantly larger than any outside diameter of cylinder portion 33 so that lid member 55 is freely movable axially along cylinder portion 33 through the opening 57. The upper surface 65 of lid member 55 forms a slight circular depression 73 which extends fully around the circumference of lid member 55. Lid member 55 includes a channel 75 or other interfitting structure between outer bottom edge 67 and inner bottom edge 71 that is engageable with top rim 19 of container 13.

The configuration shown includes a channel 75, which is optional and can be replaced with any interlocking configuration. Flat surface interaction between the bottom of the lid member 55 and the top rim 19 is possible. However an “L” shaped groove in the lid member 55 can be used with the section lying inside the container 13 able to resist the spreading of the lid member 55 which occurs at marination pressures, and in addition registry of the lid member 55 with respect to the top rim 19. In the configuration shown, the channel 75 presents three surfaces which can all be used for registry and with the section lying inside the container 13 able to resist the spreading of the lid member 55 which occurs at marination pressures. Other configurations are possible and may be dictated by the choice of materials employed.

Illustrated directly above lid member 55 is annular locking member 77. Locking member 77 forms an opening 79 adjacent a threaded inner surface 81 having an inside diameter, an circular bottom surface 83, an upper surface 85, a flat undersurface portion 87 and an outside bottom surface 89. The inside diameter of the threaded inner surface 81 of the locking member 77 is significantly larger than the first outside diameter of the first threaded outer surface 47 and optional intermediate outer surface 51 of cylinder portion 33 of plunger member 29. However, the threaded inner surface 81 threadably engages the second threaded outer surface 49 of cylinder portion 33 so that locking member 77 can be turned freely to axially move along the first threaded outer surface 47 of cylinder portion 33 but can be secured to cylinder portion 33 by rotatably engaging threaded inner surface 81 of locking member 77 with second threaded outer surface 49 of cylinder portion 33.

Note that although the cylinder portion 33 and the locking member 77 have been described as threaded, it is conceivable that they could operate similarly with a partial locking teeth arrangement whereby, for example, locking member 77 would be freely movable along cylinder portion 33 but could be locked into a selected position by partial rotation to engage teeth. Furthermore, locking member 77 could be a device such as a simple clamp fixable along cylinder portion 33.

Upper surface 85 of locking member 77 may form a pair of finger-sized depressions 91 for ease of turning locking member 77 along cylinder portion 33 and into place. In the configuration shown the outside bottom surface 89 of locking member 77 may slidingly bear against depression 73 in the upper surface 65 of lid member 55. The circular bottom surface 83 of locking member 77 opposes and may slidingly bear against the second inner surface 61 of lid member 55, and the circular bottom surface 83 of locking member 77. Such bearing surfaces will bear the downward force of the plunger member 29 through the lid member 55 once the vacuum marination device 11 is assembled and activated.

Illustrated directly above locking member 77 is an annular reservoir member 93 which includes a connector portion 95 and a cupped portion 97. Connector portion 95 has a cupped portion 97 which leads to a threaded inner surface 99. Connector portion 95 has an upper inner surface 101. The threaded inner surface 99 leads to an opening 103. The inside diameter of the connector portion 95 of reservoir member 93 threadably engages the second outside diameter of the second threaded outer surface 49 of the cylinder portion 33.

With this configuration the connector portion 95 can be fitted onto the cylinder portion 33 by rotatably engaging threaded inner surface 99 of the connector portion 95 with first threaded outer surface 47 of cylinder portion 33. The cupped portion 97 of reservoir member 93 helps to prevent spillage of marinade 27 if marinade 27 back flows up through the cylinder portion 33 of plunger member 29 once the vacuum marination device 11 is assembled and operative. Note that while cylinder portion 33 and reservoir member 93 are described as being threadable to one another, the partial locking teeth arrangement described above is also a possibility for these structures.

Illustrated directly above reservoir member 93 is a piston member 105, the first end of which is defined by a stopper 107 with a side surface 109 and a bottom surface 111, and the second end of which is defined by a handle 113 having a base portion 115. A shaft portion 117 extends between stopper 107 and base portion 115 of handle 113 and comprises a cross-shaped spine 119 which is partially enclosed by a rigid cylindrical sheath 121. Cylindrical sheath 121 defines a longitudinal opening 123 which is approximately ½ inch wide and through which cross-shaped spine 119 is visible. Cylindrical sheath 121 extends from base portion 115 of handle 113 to terminate at free edge 125, approximately ½ inch above stopper 107.

A gasket 127 is attached along the circumference of stopper 107 at side surface 109. The outside diameter of stopper 107 is slightly smaller than the inside diameter of the cylinder portion 33 of plunger member 29, but is made slightly larger by the gasket 127 so that when piston member 105 is inserted into cylinder portion 33 of plunger member 29, the gasket 127 will be compressed by the inner surface 45 of cylinder portion 33 to create a tight seal. Handle 113 has a curved shape which is generally compatible with the inner surface 101 of cupped portion 97 of reservoir member 93 such that, when the vacuum marination device 11 is assembled and is not activated, the handle 113 rests inside cupped portion 97 of reservoir member 93 for a sleek profile.

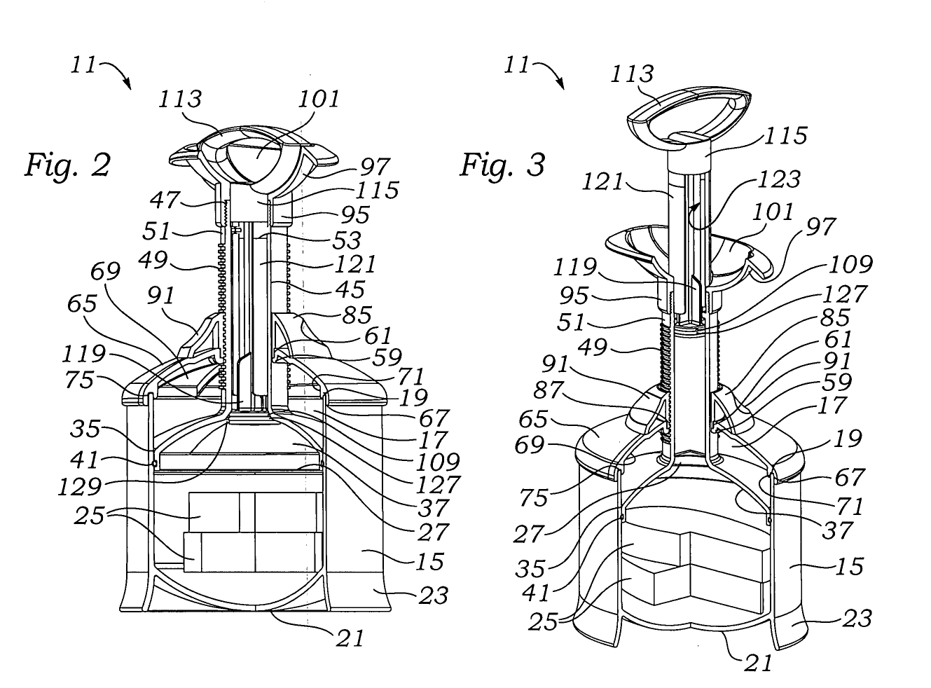

FIG. 2 is a cutaway view of the vacuum marination device 11 of FIG. 1 as assembled, and illustrates domed portion 31 of plunger member 29 inserted into container 13 to seal foodstuff 25 and marinade 27 inside container 13 in preparation for vacuum marination. Note that during insertion of domed portion 31 of plunger member 29 into container 13 to eliminate any air spaces, the piston member 105 is positioned so that it fully extends through cylinder portion 33 such that stopper 107 of piston member 105 extends past the central opening 39 of the domed portion 31 of the plunger member 29 and into the space inside the container 13 so that a gap 129 is created between the stopper 107 and the central opening 39 to permit escape of any excess air. As the domed portion 31 of the plunger member 29 is advanced into the container 13, any air in the container 13 will be forced through gap 129 and subsequently through cylinder portion 33, past shaft 117 (cross-shaped spine 119 allows for the passage of air), through opening 43 (not visible in FIG. 2) of cylinder portion 33 and into the surrounding atmosphere. A small amount of marinade would normally also pass through gap 129 once all air is expelled and signifies that the plunger member 29 has been sufficiently lowered. This small amount of marinade, when passing through gap 129, causes the piston member 105 to rise and gasket 127 to enter cylinder portion 33 and stop the flow of marinade.

FIG. 2 further illustrates lid member 55 seated on container 13 such that channel 75 of lid member 55 is fittably engaged with top rim 19 of container 13. Locking member 77 is shown threaded onto to cylinder portion 33 of plunger member 29 immediately adjacent to lid member 55 so that the position of lid member 55 is fixed relative to domed portion 31 of plunger member 29 to limit the ability of the domed portion 31 to go lower to define a fixed volume that contains a negligible volume of air. This preserves the integrity of the space surrounding the foodstuff 25 to prevent foodstuff 25 from being crushed, compressed or changed in shape matching the shape of the space between the underside of the plunger member 29 and the bottom wall 21 of the container 13.

Note that although lid member 55 and locking member 77 are illustrated as separate in FIGS. 1 and 2, they can conceivably be one fused unit in which the combination lid member 55 and locking member 77 could turn together. This could be facilitated if the profile of container 13 is circular and where the lid member 55 is circular so that the lid member can rotate while being supported by the container 13. Note that the lid member 55 need not be a solid shielding piece of material. Lid member 55 need only garner some upward lift force from the container 13 and can be an extended structure.

Further, lid member 55 and locking member 77 could also form a single unit if container 13 is oval or some other shape such as square, or rectangular, but this would require that the interface between lid member 55 and top rim 19 of container 13 be of a different configuration than the one described, such as opposing flat surfaces, for example which could turn and slidingly abut against each other. The main idea is that the connection between the container 13 and the upward force it applies to the plunger member 29 should be able to be accomplished by setting the height of the plunger member 29. Any structure which supports the plunger member 29 with respect to the container 13 is acceptable, regardless of its configuration.

FIG. 3 is a cutaway view of the vacuum marination device 11 shown in FIG. 2 in which the vacuum has been activated by extraction and locking of the piston member 105. To achieve the configuration of FIG. 3, the domed portion 31 of plunger member 29 is advanced into container 13, as described above, until the undersurface 37 of domed portion 31 is in contact with the marinade 27. As the domed portion 31 continues to be advanced into container 13, its domed shape forces the remaining air in container 13 toward central opening 39 and into the surrounding atmosphere. Once the remaining air in the container 13 has passed through gap 129 (so that the level of air in container 13 is essentially zero) and the level of marinade 27 just begins to rise up through gap 129, piston member 105 is retracted using handle 113 so that gasket 127 of stopper 107 forms a seal with inner surface 45 of cylinder portion 33 and closes gap 129. When piston member 105 is further retracted through cylinder portion 33, a vacuum begins to form inside container 13. Once the piston member 105 is fully retracted, essentially a full vacuum, i.e., a 100% vacuum wherein pressure equals zero bar, results inside container 13 (absent above considerations of gasses separating from the foodstuff 25 and any vapor pressure contribution from a water based marinade).

Handle 113 can then be turned so that free edge 125 of cylindrical sheath 121 lodges atop ledge 53 on the inner surface 45 of cylinder portion 33, effectively locking piston member 105 into position so that the vacuum can be maintained for the duration of the marination period. The surrounding atmosphere vacuum exerts a downward force on plunger member 29 against the vacuum underneath it. This force is translated to lid member 55 to keep it securely engaged with container 13 during the marination process.

As noted above, if it is noticed or suspected that small amounts of air might have escaped from foodstuff 25 once the vacuum is pulled such that there may be a slight increase the pressure inside chamber 13, handle 113 can be unlocked by turning it so that piston member 105 can return to its former position inside the cylinder portion 33 of plunger member 29. The stopper 107 can be made to extend below central opening 39 of domed portion 31 of plunger member 29 to form gap 129.

The domed portion 31 may then be adjusted downward if possible to again insure that all of the air is expelled, and the piston member 105 may again be withdrawn to again form a complete vacuum to the extent possible. Again, the residual effects from bubbling or vapor pressure from both sources are estimated to be only about 0.08 to 0.02 bar, an insignificant amount which should decrease the vacuum by only two to eight percent. Once the marination process is complete to the user's satisfaction, the pressure in container 13 can be restored to atmospheric pressure as described above. The vacuum marination device 11 can be disassembled into its separate components for removal of foodstuff 25 and marinade 27 and can be easily cleaned.

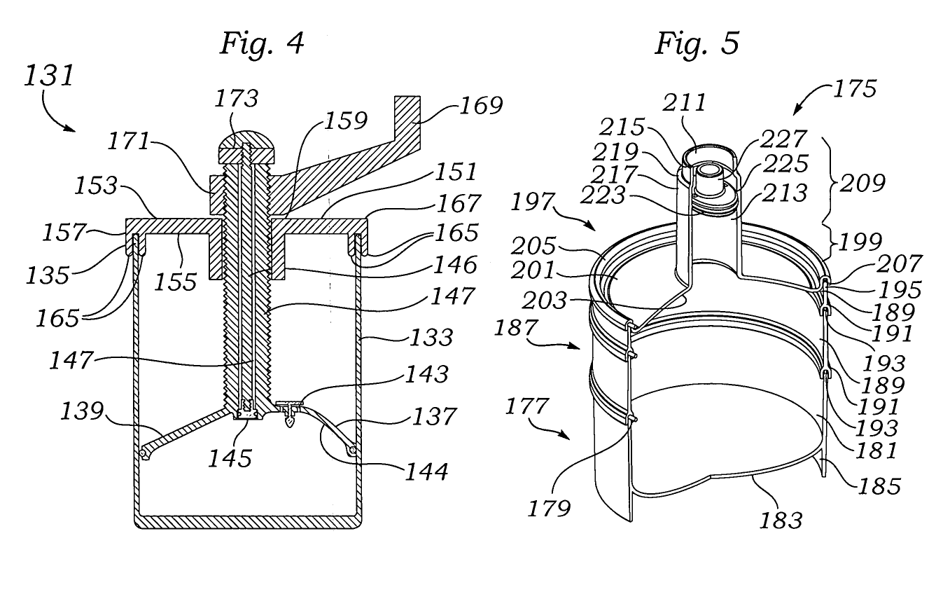

FIG. 4 is a cross-sectional view of a second embodiment of the vacuum marination device 131 of the present invention and illustrates a container 133 with a top rim 135. FIG. 4 further illustrates a plunger 137 with a top surface 139 and a bottom surface 141. Plunger 137 has an air-out valve 143 extending through plunger 137 off-center which will allow air in the container 133 to easily escape when plunger 137 is lowered as the air-out valve 143 is located at the highest point of plunger 137. The escape of air can be even more complete if the container 133 is tilted during this process.

The air-out valve 143 is positioned off-center so that, as the plunger 137 is advanced into container 133, a user can quickly detect any marinade back flow through air-out valve 143, a ready indicator for moving to the step of activating the vacuum. Plunger 137 has an air-in valve 145 at its center connected to the threaded end nut or end cap 173 by a threaded shaft 146 running through a duct 147 in a threaded annular shaft 149 to allow the passage of air back into container 133 to inactivate the vacuum once the marination process is complete. Turning of the end cap can caused the threaded shaft 146 to move axially to displace the element of the air-in valve 145. Alternatively, air-out valve 143 could be used as an air in valve as well or an air in valve could be placed anywhere that allows air into the evacuated chamber. A threaded annular shaft 147 is attached at top surface 139 of plunger 137 and forms a duct 149 which communicates with air-in valve 145.??? Threaded shaft 147 extends from plunger 137 through an annular lid 151. Lid 151 has top surface 153, bottom surface 155, an outside diameter defined by a side surface 157, and an inside diameter defined by an inner surface 159.

Bottom surface 155 may include an annular support structure 163 extending away from bottom surface 155 to provide lateral stability for threaded shaft 147 when the vacuum marination device is in the process of being activated. Bottom surface 155 includes a rim 165 extending away from bottom surface 155 and having a channel 167 therein which is engageable with top rim 135 of container 133. Once the food to be marinated (not illustrated in FIG. 4) has been placed inside container 133, lid 151 is passed over shaft 147 end cap 173 is tightened to close air in valve 145 to fix the position of and plunger 137 is lowered until all air is evacuated and a small amount of marinade comes out of air out valve 143, as shown.

Adjacent lid 151 is a handle 169 having an annular base portion 171 through which shaft 147 also extends. The inside of base portion 171 is threaded to enable the handle 169 to be is turned to cause the base portion 171 to travels to and bear against lid 151. Once bearing contact is made, further turning causes the shaft 147 to rise. Plunger 137 is of a shape to resist rotation such as elliptical, oval, square. A threaded end cap 173 is then threaded onto shaft 147 to close duct 149 and prevent influx of air into the container 133. Once end cap 173 is in place, as handle 169 is rotated, shaft 147 retracts or rises, pulling plunger 137 upward to create a vacuum inside container 133. Once the marination process is complete, end cap 173 can be removed unscrewed from threaded shaft 146 to allow air in valve 145 to drop to allow air to flow through duct 149 and back into container 133, releasing the vacuum and allowing plunger 137 to be withdrawn.

FIG. 5 is a cutaway view of a third embodiment of the vacuum marination device 175 which illustrates a container 177 with a top rim 179, side wall 181, and bottom wall 183. Bottom wall 183 is concave to allow marinade (not illustrated in FIG. 5) to reach more surface area of any foodstuff in container 177 (not illustrated in FIG. 5) and resist deformation due to the pressure experienced when the pressure in the container is lowered. Side wall 181 extends beyond bottom wall 183 to form a flange 185 on which container 177 rests. Container 177 can be extended to accommodate large volumes of food and marinade (not illustrated in FIG. 5) using intermediate stacking sections 187 of varying height.

Intermediate stacking sections 187 comprise a cylindrical wall 189 with a bottom rim 191, which forms a channel 193, and top rim 195. It is understood that channel 193 could be replaced by an inside groove, an outside groove, or other structure, and that the choice of structure may depend upon the materials of construction, their thickness, etc.

Channel 193 is engageable with top rim 179 of container 177, or with top rim 195 of any other intermediate stacking section 187. The top rim 195 of an intermediate stacking section 187 is engageable with groove 193 in any other intermediate stacking section 187. Bottom rim 191 of the intermediate stacking sections 187 may be made of a self-sealing rubber material or may contain rubber gaskets to form a tight seal once the vacuum marination device is assembled. The purpose of stacked structure is to enable any size of marinade volume to be selected.

FIG. 5 illustrates an annular lid 197 which has a domed portion 199 with a top surface 201, a bottom surface 203, and a u-shaped rim 205 forming a channel 207. Lid 197 has a cylinder portion 209 adjacent and extending away from top surface 201 of domed portion 199. Cylinder portion 209 may have a first inside diameter defined by a first inner surface 211 and a second inside diameter slightly larger than first inside diameter and defined by a second inner surface 213. Cylinder portion 209 further may have a first effective diameter first outer surface 215 (effective meaning a structure not fully circular and thus having a size which follows circumferentially) and a second outside diameter slightly larger than first outside diameter and defined by a second outer surface 217. Cylinder portion 209 has an intermediate diameter reduction transition 219 extending between first surface 211 and second surface 213 on the inside, and between first effective diameter first outer surface 215 and second outside diameter second outer surface 217.

Also illustrated in FIG. 5 is a piston base 221 with side surface 223 around which a gasket 225 extends. Piston base 221 has a connector portion 227 to which either a mechanical or manual piston (not shown in FIG. 5) may be connected to activate a vacuum inside container 177 extended by intermediate stacking sections 187. Piston base 221 is axially movable along the inside surface of the cylinder portion 209. intermediate diameter reduction transition 219 prevents piston base 221 from being pulled out of cylinder portion 209 when retracted to create a vacuum.

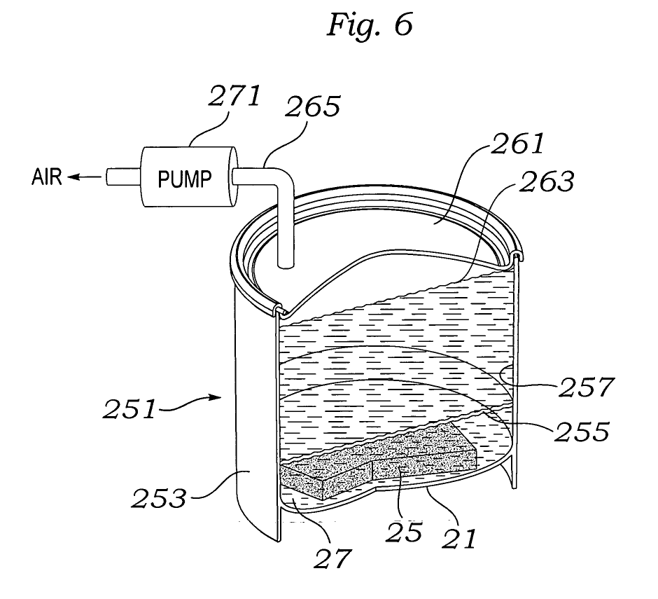

Referring to FIG. 6, a cutaway view of a fourth embodiment of the vacuum marination device is seen as a vacuum marination device 251 having a container 253 which illustrates a fixed containment volume container that can be used without need for a plunger device. The advantage of container 253 is that it provides one open-ended cylindrical containment with only one open end and without the stacking structure seen in FIG. 5. Conversely, the fixed volume container 253 provides a constant volume for a low amount of foodstuff 25. The result would be a significant volume of air to be pumped out, or a large volume of marinade.

However a separation plate 255 is utilizable as a preventative mixing barrier 255. It is preferred that the separation plate 255 have a close relationship with an internal smooth surface 257. This close relationship may range from non-sealing to partially sealing, as will be explained in the operations section.

Atop the lid 261, a fitting 265 is provided. The fitting 265 can be used to indicate the level of any liquids due to either overfilling or compression of the lid 261, to help protect a pump 271. Pump 271 can be a powered pump or it can be a stand-alone remote plunger or syringe which can be used to create a vacuum.

In terms of operation, the empty container 253 is loaded with foodstuff items 25. Preferably the foodstuff 25 will be arranged so that there is a minimum space left about the periphery of the foodstuff. In this manner, only a minimum amount of marinade can be added to cover the foodstuff 25.

Next, the preventative mixing barrier 255 is pressed down within the container 253 either generally parallel to the surface of the marinade 27. In the alternative, the preventative mixing barrier 255 which may be flexible, may be pressed down within the container 253 at an angle. In either case, air is allowed to pass around the preventative mixing barrier 255 as it is pressed down. At the bottom of its travel, it is flattened in orientation so that all of the air is passed around the preventative mixing barrier 255 and the level of the marinade 27 may preferably overlie the preventative mixing barrier 255 only slightly. The resulting orientation is that the only structures below the preventative mixing barrier 255 is the foodstuff 25 and maranade 27.

Next, a fill liquid may be added above the preventative mixing barrier 255. In the worst case, where the marinade 27 and fill liquid are water based or where the where the marinade 27 and fill liquid are oil based, the preventative mixing barrier 255 generally impedes dilution of the marinade 27 due to the barrier to mixing. The barrier to mixing operates both through physically isolating the marinade 27 from turbulence during the pouring of the fill liquid and secondarily by limiting the mixing or dilution mechanism to diffusion only. The diffusion will be limited to occur only through any slight opening between the top and bottom of the preventative mixing barrier 255. Given the short time and relatively non-active temperatures during the marinade process, the preventative mixing barrier 255 works well.

In the case where the marinade 27 is water based and the fill liquid 263 is oil based (and therefore presumably lighter than the marinade) the water-oil barrier, in addition to the preventative mixing barrier 255 acts to maximally prevent mixing. In the case where the marinade 27 is oil based and the fill liquid 263 is water based, it will be preferable to provide additional sealing between the mixing barrier 255 and the internal smooth surface 257. Other structures can be employed to insure a better seal, such as plastic wrap or other structures where necessary to take up the spacing between the internal smooth surface 257 and the preventative mixing barrier 255 to help prevent any tendency for an oil based marinade 27 from trying to rise past the internal smooth surface 257. The reventative mixing barrier 255 made from an oversized, deformable polymeric material to enable providing a more complete seal with respect to the internal smooth surface 257.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A vacuum marination device comprising:
A container having an open end, a closed end oppositely disposed from said open end, and a middle portion extending between said open end and said closed end, said middle portion having an inside surface and an outside surface;
an annular plunger member having a first end and a second end oppositely disposed from said first end, and wherein said annular plunger member has a plunger portion adjacent said first end and has an annular cylinder portion, having an inside cylinder wall adjacent said second end, and an outer surface, said plunger portion having a circumferentially outward most side which is complementary to said inside surface of said middle portion of said container and sealably fittable with respect to said inside surface of said middle portion open end of said container, creating a seal between said side surface of plunger portion and said inside surface of said middle portion while said plunger portion is axially movable inside said container substantially throughout said inside surface of said middle portion;
a piston member, said piston member having a first end, a second end oppositely disposed from said first end, and a shaft extending between said first and second ends, and wherein the circumference of said first end of piston member corresponds to the circumferential shape and size of said, an inside cylinder wall of said cylinder portion of said annular plunger member such that said piston member is sealably fittable inside said cylinder portion and axially movable therein; and
an annular lid member having a first portion engageable with said rim at said open end of container and a second portion engageable with said annular cylinder portion of said annular plunger member.

2. The vacuum marination device recited in claim 1 wherein said lateral surface of annular lid member forms a channel, said channel engageable with said rim at said open end of container.

3. The vacuum marination device recited in claim 1 wherein said piston member is axially movable inside said cylinder portion of annular plunger member between a first neutral position, wherein said first end of said piston member extends beyond said second main surface of said plunger portion of annular plunger member to form an air gap, a second sealing position, wherein said first end of said piston member is minimally retracted inside said cylinder portion of annular plunger member to eliminate said air gap, and a third vacuum position, wherein said first end of said piston member is maximally retracted inside said cylinder portion of annular plunger member.

4. The vacuum marination device recited in claim 3 wherein said annular lid member is selectively lockably engageable with said locking member of said cylinder portion of said annular plunger member to enable said locking member of said cylinder portion to be locked at a pre-selected user determined level.

5. The vacuum marination device recited in claim 4 wherein said locking members of annular lid member and said outer surface of said cylinder portion of annular plunger member are at least one of threads and teeth.

6. The vacuum marination device recited in claim 4 and further comprising a locking ring fittable onto said cylinder portion of said annular plunger member, and a locking member engageable with said locking member on said cylinder portion of annular plunger member.

7. The vacuum marination device recited in claim 6 wherein said locking member on said locking ring and said outer surface of cylinder portion of annular plunger member are at least one of threads and teeth.

8. The vacuum marination device recited in claim 6 wherein said vacuum marination device further comprises a reservoir member, said reservoir member having a first end and a second end oppositely disposed from said first end, said first end forming a cylindrical connector and said second end forming a cup, said first end of said reservoir member attached adjacent said second end of annular plunger member.

9. A vacuum marination device comprising:
a container having an open end, a closed end oppositely disposed from said open end, and a middle portion extending between said open and said closed end, said middle portion having an inside surface and an outside surface, and wherein said container has a rim extending between said inside and outside surfaces at said open end;
a plunger having a first end and a second end said first end having a circumferential member forming a sealed sliding engagement with respect to said inside surface of said middle portion, and wherein said plunger is axially movable inside said container;
a support, having a first end connected to said rim of said container, and a second end connected between said first and said second ends of said plunger, to support said plunger from said rims of said container when a vacuum is formed between said first end of said plunger and said closed end of said container;
a threaded shaft having a first end, said first end attached to said first end of said plunger and extending beyond said support;
a nut having an internal thread and engaging said threaded shaft, said nut operable against said support raise said threaded shaft to create a reduction in pressure between said plunger first end and said closed end of said container.

10. The vacuum marination device recited in claim 9 wherein said support includes a channel, said channel engageable with said rim at said open end of container.

11. The vacuum marination device recited in claim 9 wherein said plunger has at least one opening extending through said circumferential member.

12. The vacuum marination device recited in claim 11 wherein said at least one opening includes a valve.

13. The vacuum marination device recited in claim 12 wherein said threaded shaft has a duct, said duct extending axially through said threaded shaft, and wherein said valve in said at least one opening open into said duct of said threaded shaft.

14. The vacuum marination device recited in claim 13 and further comprising an end cap, said end cap engageable with said second end of threaded shaft.

15. The vacuum marination device recited in claim 15 and further comprising a handle, said handle extending from a lateral side of said nut.

16. A vacuum marination device comprising:
a container having an open end, a closed end oppositely disposed from said open end, and a middle portion extending between said open end and said closed end, said middle portion having an inside surface and an outside surface, and wherein said container has a container rim between said inside and outside surfaces at said open end;
an annular lid member having a first end and a second end oppositely disposed from said first end, and wherein said annular lid member has a base portion adjacent said first end and a cylinder portion adjacent said second end, said cylinder portion having an inner surface and an outer surface, said base portion having a first main surface adjacent said outer surface of cylinder portion, a second main surface oppositely disposed from said first main surface, and wherein said first and second main surfaces meet at a lid rim, and wherein said lid rim is engageable with said container rim at said open end of container;
a piston member, said piston member having a first surface, a second surface oppositely disposed from said first surface, and a side surface extending between said first and second surfaces, and having a connector attached to said first surface, and wherein the circumferential size and shape of said side surface of piston member corresponds to the inner surface of said cylinder portion such that said piston member is sealably fittable inside said cylinder portion and axially movable therein.

17. The vacuum marination device recited in claim 17 and further comprising at least one intermediate stacking member, said at least one intermediate stacking member comprising a wall, the circumferential shape and size of which corresponds to the circumferential shape and size of both said open end of container and said lid rim of annular lid member, and wherein said wall forms a first intermediate rim and a second intermediate rim, said first intermediate rim engageable with said lid rim of said annular lid member and wherein said second intermediate rim is engageable with said container rim.

18. The vacuum marination device recited in claim 17 and further comprising a plurality of intermediate stacking members serially stacked between said lid rim of said annular lid member and said container rim of said container.

19. The vacuum marination device recited in claim 19 said second intermediate rim of said intermediate stacking member forms a channel, said channel engageable with said container rim at said open end of container and with said first intermediate rim of said wall of an other one of said intermediate stacking members.

20. A method of creating a high level of vacuum in a marinator in which the foodstuff and marinade are placed in a sealed container and all air is removed by adjusting the volume of the container, sealing the container, then increasing the volume of the container by a small amount to create a void that contains a high level of vacuum.

21. A method of creating a high level of vacuum in a marinator in which the foodstuff and marinade are placed in a sealed container displacing all air, sealing the container, then increasing the volume of the container by a small amount to create a void that contains a high level of vacuum.

22. The device of 20 or 21 in which the means to increase the volume is a plunger and bore.

23. The device of 22 in which the plunger is in contact with the marinade before activation.
